(19) United States
(12) Patent Application Publication
(10) Pub. No.: US 2016/0262452 A1
(43) Pub. Date: Sep. 15, 2016

(54) ELECTRONIC CIGARETTES HAVING ADJUSTABLE VAPORIZER

(71) Applicant: SHENZHEN KANGER TECHNOLOGY CO., LTD, Shenzhen, Guangdong (CN)

(72) Inventor: Xiaochun Zhu, Shenzhen, Guangdong (CN)

(21) Appl. No.: 14/395,299

(22) PCT Filed: Sep. 24, 2014
(86) PCT No.: PCT/CN2014/087329

§ 371 Date: Oct. 17, 2014

(30) Foreign Application Priority Data
Jul. 17, 2014 (CN) 20142039683.10

(51) Int. Cl. A24F 47/00; F22B 1/28; H05B 1/02

(52) U.S. Cl. CPC A24F 47/008; H05B 1/0291; H05B 1/0297; F22B 1/284

(57) ABSTRACT

The present invention relates to electronic cigarette having adjustable vaporizer. In certain embodiments, the electronic cigarette includes: a mouth piece assembly, a heating assembly, an electric connector assembly, an e-liquid storage assembly, and a vapor adjusting ring. The mouth piece assembly has a mouth piece connector, a mouth piece attached to the mouth piece connector, and a vapor tube. An upper end of e-liquid storage assembly is connected to mouth piece assembly through an e-liquid injection tube which is detachably inserted into vapor tube. Heating assembly is disposed inside of the e-liquid storage assembly. The electric connector assembly includes a lower tubular body electrically connected to a connecting ring assembly and an upper tubular body. One end of upper tubular body is threaded into the mouth piece assembly and another end is threaded into connecting ring assembly 6. The present invention also provides a method to adjust e-cigarette's vapor flow.

### CROSS-REFERENCE TO RELATED APPLICATIONS

This application claims priority of Chinese patent application 201420396831.0, filed with the State Intellectual Property Office of China on Jul. 17, 2014, entitled “Electronic cigarette having adjustable vaporizer”, by Xiaochun ZHU, the disclosures of which are incorporated herein in their entireties by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD

The present invention generally relates to the field of electronic cigarette (or e-cigarette), and more particularly to electronic cigarettes having adjustable vaporizer, and methods of using the electronic cigarettes having adjustable vaporizer.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

It is well known that smoking cigarette is harmful to smoker's health. The active ingredient in a cigarette is mainly nicotine. During smoking, nicotine, along with tar aerosol droplets produced in the cigarette burning, are breathed into the alveolus and absorbed quickly by the smoker. Once nicotine is absorbed into the blood of the smoker, nicotine then produces its effect on the receptors of the smoker's central nervous system, causing the smoker relax and enjoy an inebriety similar to that produced by an exhilarant.

The electronic cigarette is sometimes referred as electronic vaporing device, personal vaporizer (PV), or electronic nicotine delivery system (ENDS). It is a battery-powered device which simulates tobacco smoking It generally uses a heating element that vaporizes a liquid solution (e-liquid). Some solutions contain a mixture of nicotine and a variety of flavorings, while others release a flavored vapor without nicotine. Many are designed to simulate smoking experience, such as cigarette smoking or cigar smoking. Some of them are made with similar appearance, while others are made considerably different in appearance.

Conventional electronic cigarettes are made with a mouth piece assembly, a vaporizer assembly, an electric connecting assembly, and an e-liquid storage assembly. The mouth piece is installed on top of the e-liquid storage assembly, and the vaporizer assembly is installed inside of the e-liquid storage assembly, and electrically connected to a DC power source through the electric connecting assembly. The mouth piece assembly is connected to the vaporizer assembly and forms an air flow passage. The e-liquid is stored in the e-liquid storage assembly. The e-liquid flows through a vaporizing chamber of the heating assembly using fiber threads. The e-liquid in the fiber threads is then heated by a heating wire of the heating assembly and therefore vaporized. The vaporized e-liquid goes up to the mouth piece such that a smoker enjoys the vaporized e-liquid. However, the vapor flow and the quantity and speed of e-liquid vaporization are not controllable or adjustable to meet the different demands of various electronic cigarette smokers.

Therefore, heretofore unaddressed needs exist in the art to address the aforementioned deficiencies and inadequacies.

### SUMMARY

In one aspect, the represent invention relates to an electronic cigarette having adjustable vaporizer. In certain embodiments, the electronic cigarette includes: a mouth piece assembly, a heating assembly, an electric connector assembly, an e-liquid storage assembly, and a vapor adjusting ring for adjusting vapor flow. The mouth piece assembly has an upper end, and an opposite, lower end, a mouth piece connector, a mouth piece, and a vapor tube. The mouth piece is detachably positioned on the mouth piece connector. The vapor tube extends downwards from the lower end of the mouth piece assembly. The e-liquid storage assembly has an upper end, and an opposite, lower end. The upper end of the e-liquid storage assembly is detachably connected to the lower end of the mouth piece assembly through an e-liquid injection tube. The e-liquid injection tube is detachably inserted into the vapor tube. The heating assembly has one or more ceramic e-liquid media for absorbing e-liquid to be vaporized, one or more heating wires to vaporize the e-liquid absorbed in the ceramic e-liquid media. Each of the heating wires has a positive terminal and a negative terminal. The heating assembly is disposed inside of the e-liquid storage assembly. The electric connector assembly includes a lower tubular body, and the lower tubular body is electrically connected to a connecting ring assembly and an upper tubular body. The upper tubular body has an upper end threaded into the lower end of the mouth piece assembly and an opposite, lower end threaded into an upper end of the connecting ring assembly.

In certain embodiments, the electronic cigarette includes one or more vapor tubes, one or more heating assemblies, and one or more e-liquid storage assemblies. The number of the vapor tubes, the number of heating assemblies, and the number of e-liquid storage assemblies are the same. Each of the heating assemblies has an e-liquid injection tube detachably inserted into a corresponding vapor tube of the mouth piece assembly. Each of the heating assemblies is disposed inside of a corresponding e-liquid storage assembly. In one embodiment, the electronic cigarette includes two vapor tubes, two heating assemblies, and two e-liquid storage assemblies.

In certain embodiments, the electric connector assembly includes: a body connector, an electric connector plate, an electric contact pin extended downward, a negative connector terminal, and a positive connector terminal. The body connector is sleeved and sealed outside of the one or more e-liquid storage assemblies. The negative connector terminal is electrically connected to the body connector. The positive connector terminal is electrically connected to the electric connector plate and the electric contact pin. The positive connector terminal is electrically insulated from the body connector and the negative connector terminal. The electronic cigarette further includes an insulation layer placed between the body connector and the electric connector plate.

In one embodiment, the electric contact pin is a metal contact pin and it is electrically connected to the electric connector plate through a retractable connection. In another embodiment, the electric contact pin is electrically connected to the electric connector plate through a threaded connection.

In certain embodiments, the body connector has: a lower tubular body, multiple body air intake holes, a protrusion ring. The lower tubular body is rotatably sleeved with a vapor adjusting ring. The multiple body air intake holes are arranged along the perimeter of the lower tubular body. The protrusion ring is extended radially to align with an outside edge of the vapor adjusting ring. The vapor adjusting ring has a vapor adjusting groove. The vapor adjusting groove is used to adjust air intake. A user can turn the vapor adjusting ring in one direction to cover more of the multiple body air intake holes to decrease the air intake. The user can turn the vapor adjusting ring in an opposite direction to uncover more of the multiple body air intake holes to increase the air intake.

In certain embodiments, each of the one or more e-liquid storage assemblies includes: a vaporizer air intake hole, an electric connector tube, an e-liquid injection tube, and an e-liquid storage tube. The e-liquid storage tube has an upper end, and an opposite, lower end. The upper end of the e-liquid storage tube is connected to the e-liquid injection tube. The lower end of the e-liquid storage tube is connected to the electric connector tube.

In certain embodiments, the path of air flow includes: the body air intake holes on the lower tubular body, the vaporizer air intake holes, the e-liquid storage assemblies, the e-liquid injection tubes, the vapor tubes, and the mouth piece. Each e-liquid injection tube of the one or more e-liquid storage assemblies is electrically connected to the electric connector plate. Each of the positive terminals of the one or more heating assemblies is electrically connected to a corresponding e-liquid storage tube, a corresponding electric connector tube, the electric connector plate, and the corresponding electric contact pin. Each of the negative terminals of the one or more heating assemblies is electrically connected to the body connector.

In certain embodiments, the body connector is engaged with a threaded connecting ring. The internal wall of the threaded connecting ring is threadedly engaged with the one or more e-liquid storage assemblies. The external wall of the threaded connecting ring is threadedly engaged with the body connector. The threaded connecting ring has a threaded connecting ring support. The threaded connecting ring support extends radially to be aligned with the outside edge of the vapor adjusting ring. The connecting ring assembly sits on the threaded connecting ring support, and is supported by the threaded connecting ring support. The connecting ring assembly is rotatably engaged with the threaded connecting ring support.

In certain embodiments, the vapor adjusting ring includes an upper end, and an opposite, lower end. The lower end of the vapor adjusting ring is rotatably and slidably engaged with the protrusion ring of the electric connector assembly. The protrusion ring of the electric connector assembly includes a position limit pin extending upward along the axis of the protrusion ring. The vapor adjusting ring has an arc shaped position limiting groove. The arc shaped position limiting groove is slidably engaged with the position limit pin to limit angle of the rotation of the vapor adjusting ring.

In certain embodiments, the mouth piece is removable such that e-liquid can be refilled by removing the mouth piece and injecting e-liquid through the each of e-liquid injection tube of the plurality of the e-liquid storage assemblies.

In another aspect, the present invention relates to a method of adjusting vapor flow of an electronic cigarette. The electronic cigarette has a vapor adjusting ring, and multiple body air intake holes. The vapor adjusting ring is used by a user to adjust vapor flow in the electronic cigarette. In certain embodiments, the method includes an operation of rotating a vapor adjusting ring of the electronic cigarette. The rotating operation includes: rotating the vapor adjusting ring in one direction to uncover more of a plurality of the body air intake holes to increase vapor flow, and rotating the vapor adjusting ring in an opposite direction to cover more of the plurality of the body air intake holes to decrease the vapor flow.

The present invention provides following advantages:
(a) By using a vapor adjusting ring, the body air intake holes can be partially covered and the air and vapor flow is adjustable, and can be precisely controlled;
(b) Having more than one heating elements, the amount of e-liquid vaporization can be increased to meet smokers demands;
(c) The structure of the electronic cigarette is simple and easy to assemble and disassemble;
(d) Having proper sealing element, the e-liquid leakage is prevented; and
(e) The electric contact pin can be adjusted through its thread, it is convenient to adapt to different type of DC power supplies.

These and other aspects of the present invention will become apparent from the following description of the preferred embodiment taken in conjunction with the following drawings, although variations and modifications therein may be effected without departing from the spirit and scope of the novel concepts of the invention.

### BRIEF DESCRIPTION OF THE DRAWINGS

The accompanying drawings illustrate one or more embodiments of the invention and, together with the written description, serve to explain the principles of the invention.

Wherever possible, the same reference numbers are used throughout the drawings to refer to the same or like elements of an embodiment. The drawings do not limit the present invention to the specific embodiments disclosed and described herein. The drawings are not necessarily to scale, emphasis instead being placed upon clearly illustrating the principles of the invention, and wherein:

FIG. 1 is a perspective view of an e-cigarette having adjustable vaporizer according to certain embodiments of the present invention;

FIG. 2 shows a cross sectional view of the e-cigarette according to certain embodiments of the present invention;

FIG. 3 shows a perspective view of a body connector of the e-cigarette according to one embodiment of the present invention; and

FIG. 4 shows a perspective view of a vapor adjusting ring of the e-cigarette according to certain embodiments of the present invention.

### DETAILED DESCRIPTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom”, “upper” or “top,” and “front” or “back” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximates, meaning that the term “around”, “about” or “approximately” can be inferred if not expressly stated.

Many specific details are provided in the following descriptions to make the present invention be fully understood, but the present invention may also be implemented by using other manners different from those described herein, so that the present invention is not limited by the specific embodiments disclosed in the following.

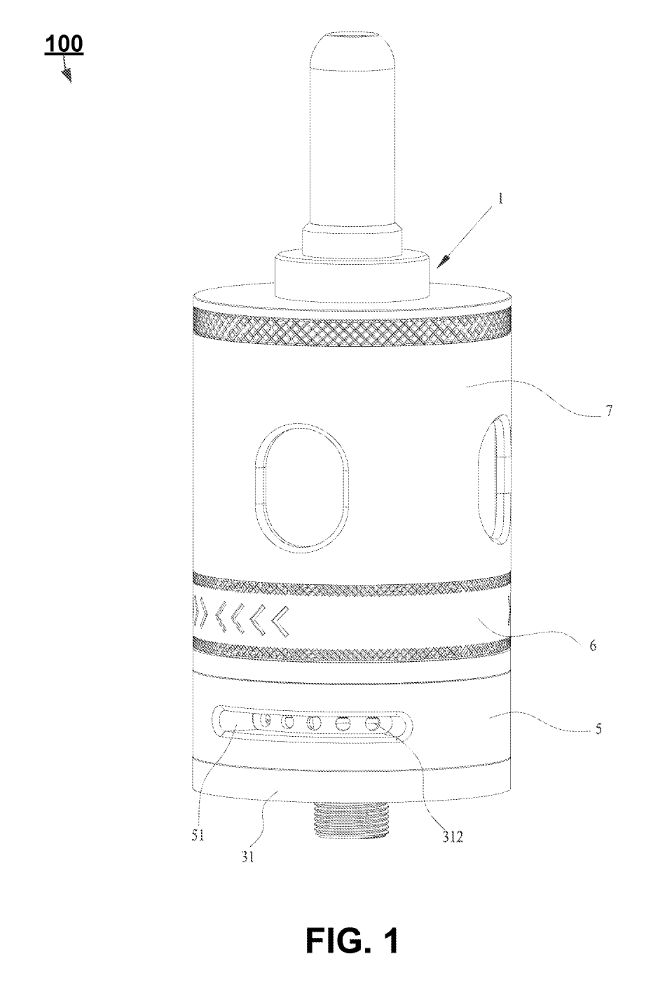

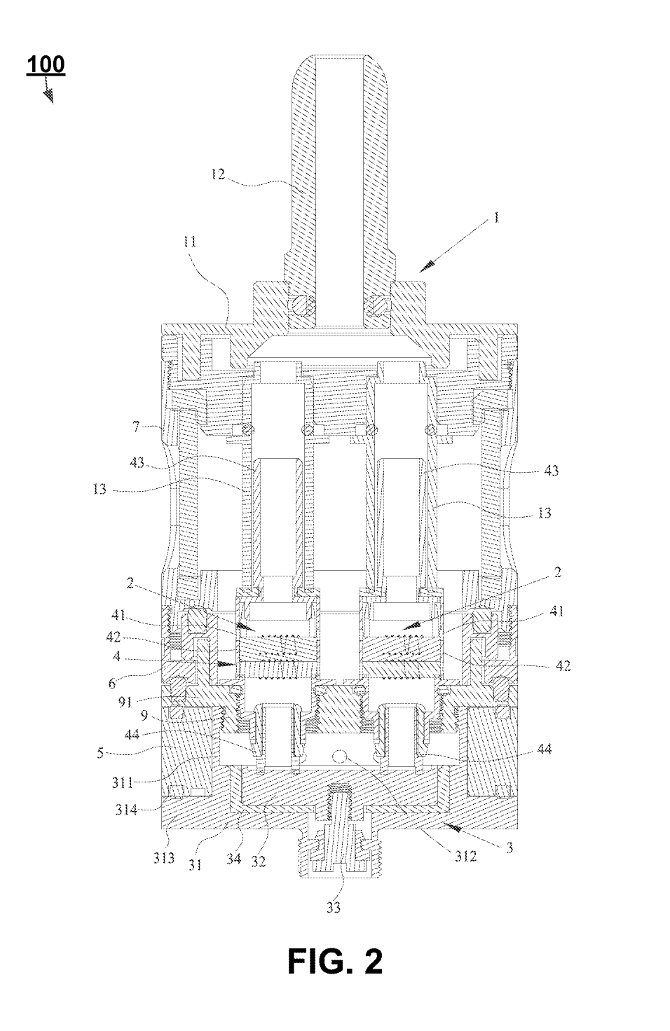

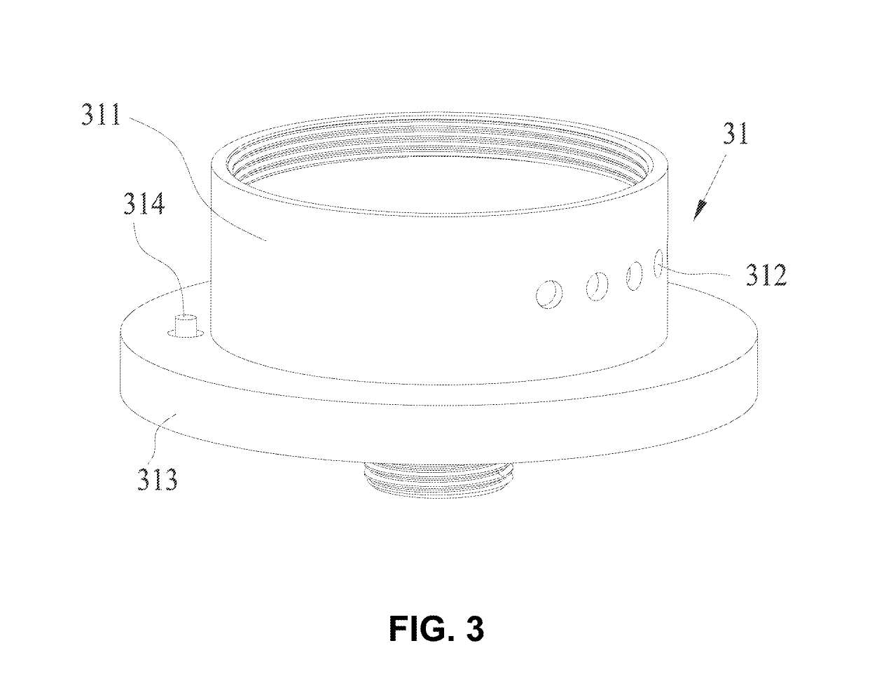

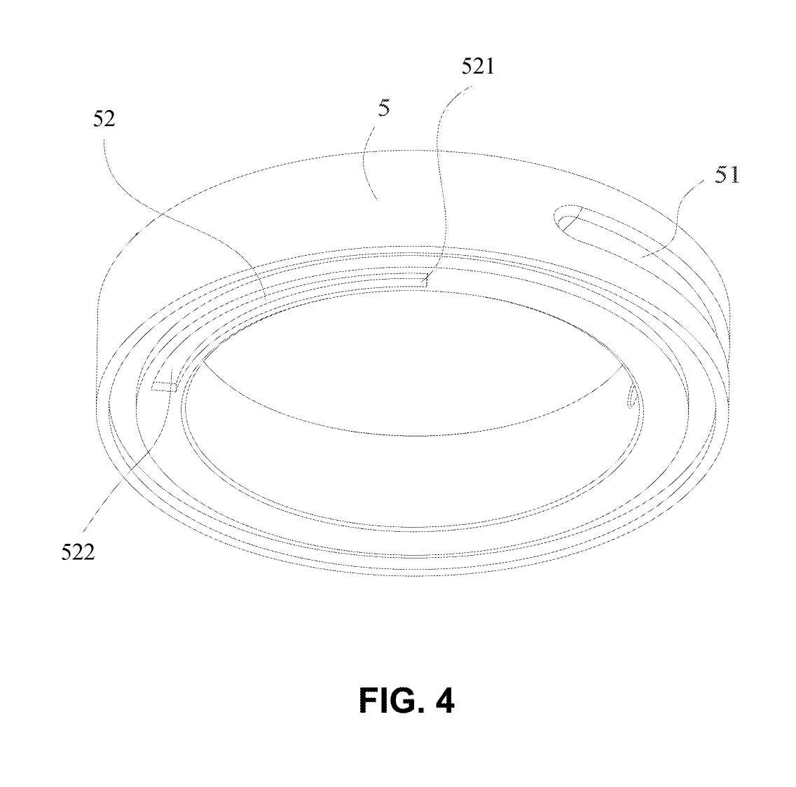

The description will be made as to the embodiments of the present invention in conjunction with the accompanying drawings FIGS. 1 through 4. FIG. 1 shows a perspective view of an e-cigarette 100 having adjustable vaporizer according to certain embodiments of the present invention. FIG. 2 shows a cross sectional view of the e-cigarette 100 shown in FIG. 1. FIGS. 3 and 4 show perspective views of a body connector 31, and a vapor adjusting ring 5 of the e-cigarette 100 according to certain embodiments of the present invention.

In accordance with the purposes of this invention, as embodied and broadly described herein, this invention, in one aspect, relates to an electronic cigarette (e-cigarette) having adjustable vaporizer.

In certain embodiments, as shown in FIG. 1 and FIG. 2, the electronic cigarette 100 includes: a mouth piece assembly 1, a heating assembly 2, an electric connector assembly 3, an e-liquid storage assembly 4, and a vapor adjusting ring 5. The mouth piece assembly 1 has an upper end, and an opposite, lower end, a mouth piece connector 11, a mouth piece 12, and a vapor tube 13. The mouth piece 12 is detachably disposed on the mouth piece connector 11. The vapor tube 13 extends downwards from the lower end of the mouth piece assembly 1. The e-liquid storage assembly 4 has an upper end, and an opposite, lower end. The upper end of the e-liquid storage assembly 4 is detachably connected to the lower end of the mouth piece assembly 1 through an e-liquid injection tube 43. The e-liquid injection tube 43 is detachably inserted into the vapor tube 13. The heating assembly 2 has one or more ceramic e-liquid media for absorbing e-liquid to be vaporized, one or more heating wires to vaporize the e-liquid absorbed in the ceramic e-liquid media.

Each of the heating wires has a positive terminal and a negative terminal. The heating assembly 2 is disposed inside of the e-liquid storage assembly 4. The electric connector assembly 3 includes a lower tubular body 311, and the lower tubular body 311 is electrically connected to a connecting ring assembly 6 and an upper tubular body 7. The upper tubular body 7 has an upper end threaded into the lower end of the mouth piece assembly 1 and an opposite, lower end threaded into an upper end of the connecting ring assembly 6.

In certain embodiments, as shown in FIG. 1, the vapor adjusting ring 5 is located near the bottom of the electronic cigarette 100. The lower tubular body 311 has a number of body air intake holes 312. In this example, there are 5 body air intake holes 312 shown in FIG. 1. The vapor adjusting ring 5 has a vapor adjusting groove 51 located in the mid-section of the vapor adjusting ring 5 and correspond to the body air intake holes 312.

The vapor adjusting ring 5 is rotatable. As shown in FIG. 1, when it is in a “fully on” position, all body air intake holes 312 are exposed by the vapor adjusting groove 51 allowing maximum air and vapor flow through the electronic cigarette 100. When it is in an “off” position, all body air intake holes 312 are covered by the body of the vapor adjusting ring 5 and external air will not flow into the electronic cigarette 100. If a user turns the vapor adjusting ring 5 counter-clockwise, more and more body air intake holes 312 will be covered, and the air and vapor flow will decrease until the body air intake holes 312 are completely covered (e.g. “off” position). If the user turns the vapor adjusting ring 5 clockwise, more and more body air intake holes 312 will be uncovered, and the air and vapor flow will increase until the all body air intake holes 312 are completely exposed (e.g. “fully on” position).

The vapor tube 13, the heating assembly 2, and the e-liquid storage assembly 4 of the electronic cigarette 100 form a vaporizer assembly. In certain embodiments, the electronic cigarette 100 may include more than one set of the vaporizer assembly. In another words, the electronic cigarette 100 may include more than one vapor tube 13, more than one heating assembly 2, and more than one e-liquid storage assembly 4. However, the number of the vapor tubes 13, the number of heating assemblies 2, and the number of e-liquid storage assemblies 4 used should be the same. Each of the heating assemblies 2 has an e-liquid injection tube 43 detachably inserted into a corresponding vapor tube 13 of the mouth piece assembly 1. Each of the heating assemblies 2 is disposed inside of a corresponding e-liquid storage assembly 4. In the embodiment shown in FIG. 2, the electronic cigarette 100 includes two sets of vaporizer assembly, i.e. two vapor tubes 13, two heating assemblies 2, and two e-liquid storage assemblies 4.

In certain embodiments, the electric connector assembly 3 includes: a body connector 31, an electric connector plate 32, an electric contact pin 33 extended downward, a negative connector terminal, and a positive connector terminal. The body connector 31 is sleeved and sealed outside of the one or more e-liquid storage assemblies 4. The negative connector terminal is electrically connected to the body connector 31. The positive connector terminal is electrically connected to the electric connector plate 32 and the electric contact pin 33. The positive connector terminal is electrically insulated from the body connector 31 and the negative connector terminal. The electronic cigarette 100 further includes an insulation layer 34 placed between the body connector 31 and the electric connector plate 32.

In one embodiment, the electric contact pin 33 is a metal contact pin and it is electrically connected to the electric connector plate 32 through a retractable connection. In another embodiment, the electric contact pin 33 is electrically connected to the electric connector plate 32 through a threaded connection.

Referring now to FIG. 3 and FIG. 4, in certain embodiments, the body connector 31 has: a lower tubular body 311, multiple body air intake holes 312, a protrusion ring 313, and a position limiting pin 314. The lower tubular body 311 is rotatably sleeved with a vapor adjusting ring 5. The multiple body air intake holes 312 are arranged along the perimeter of the lower tubular body 311. The protrusion ring 313 is extended radially to align with an outside edge of the vapor adjusting ring 5. The vapor adjusting ring 5 has a vapor adjusting groove 51. The vapor adjusting groove 51 is used to adjust air intake. The length of the vapor adjusting groove 51 is set to be long enough to expose all body air intake holes 312. A user can turn the vapor adjusting ring 5 in one direction to cover more of the multiple body air intake holes 312 to decrease the air intake. The user can turn the vapor adjusting ring 5 in an opposite direction to uncover more of the multiple body air intake holes 312 to increase the air intake.

In certain embodiments, each of the one or more e-liquid storage assemblies 4 includes: a vaporizer air intake hole 41, an electric connector tube 44, an e-liquid injection tube 43, and an e-liquid storage tube 42. The e-liquid storage tube 42 has an upper end, and an opposite, lower end. The upper end of the e-liquid storage tube 42 is connected to the e-liquid injection tube 43. The lower end of the e-liquid storage tube 42 is connected to the electric connector tube 44.

In certain embodiments, each e-liquid injection tube 43 of the one or more e-liquid storage assemblies 4 is electrically connected to the electric connector plate 32, and each of the positive terminals of the one or more heating assemblies 2 is electrically connected to a corresponding e-liquid storage tube 42, a corresponding electric connector tube 44, the electric connector plate 32, and the corresponding electric contact pin 33. Each of the negative terminals of the one or more heating assemblies 2 is electrically connected to the body connector 31. When the positive connector terminal and the negative connector terminal of the electric connector assembly 3 are connected to a DC power source, the one or more heating assemblies 2 are energized and the e-liquid in the one or more e-liquid storage assemblies 4 is heated and vaporized by the one or more heating assemblies 2.

The path of air and vapor flow includes: the body air intake holes 312 on the lower tubular body 311, the vaporizer air intake holes 41, the e-liquid storage assemblies 4, the e-liquid injection tubes 43, the vapor tubes 13, and the mouth piece 12.

In certain embodiments, the body connector 31 is engaged with a threaded connecting ring 9. The internal wall of the threaded connecting ring 9 is threadedly engaged with the one or more e-liquid storage assemblies 4. The external wall of the threaded connecting ring 9 is threadedly engaged with the body connector 31. The threaded connecting ring 9 has a threaded connecting ring support 91. The threaded connecting ring support 91 extends radially to be aligned with the outside edge of the vapor adjusting ring 5. The connecting ring assembly 6 sits on the threaded connecting ring support 91, and is supported by the threaded connecting ring support 91. The connecting ring assembly 6 is rotatably engaged with the threaded connecting ring support 91.

In certain embodiments, the vapor adjusting ring 5, as shown in FIG. 4, includes an upper end, and an opposite, lower end. The lower end of the vapor adjusting ring 5 is rotatably and slidably engaged with the protrusion ring 313 of the electric connector assembly 3. The protrusion ring 313 of the electric connector assembly 3 includes a position limiting pin 314 extending upward along the axis of the protrusion ring 313. The vapor adjusting ring 5 has an arc shaped position limiting groove 52. The arc shaped position limiting groove 52 has a first end 521, and a second end 522. The arc shaped position limiting groove 52 is slidably engaged with the position limiting pin 314 to limit angle of the rotation of the vapor adjusting ring 5. The length of the arc shaped position limiting groove 52 determines the angle of the vapor adjusting ring 5 rotation. When the position limiting pin 314 is moved to the first end 521 of the arc shaped position limiting groove 52, the electronic cigarette 100 is set to the “fully on” position. When the position limiting pin 314 is moved to the second end 522 of the arc shaped position limiting groove 52, the electronic cigarette 100 is set to the “off” position.

In certain embodiments, the mouth piece 12 is removable such that e-liquid can be refilled by removing the mouth piece 12 and injecting e-liquid through the each of e-liquid injection tube 43 of the plurality of the e-liquid storage assemblies 4.

In another aspect, the present invention relates to a method of adjusting vapor flow of an electronic cigarette 100. The electronic cigarette 100 has a vapor adjusting ring 5, and multiple body air intake holes 312. The vapor adjusting ring 5 is used by a user to adjust air and vapor flow in the electronic cigarette 100. In certain embodiments, the method includes an operation of rotating a vapor adjusting ring 5 of the electronic cigarette 100. The rotating operation includes: rotating the vapor adjusting ring 5 in one direction to uncover more of the body air intake holes 312 to increase air and vapor flow, and rotating the vapor adjusting ring 5 in an opposite direction to cover more of the body air intake holes 312 to decrease the air and vapor flow.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims, the foregoing description and the exemplary embodiments described therein, and accompanying drawings.

What is claimed is:

1. An electronic cigarette having adjustable vaporizer, comprising:
a mouth piece assembly having an upper end, and an opposite, lower end, a mouth piece connector, a mouth piece detachably disposed on the mouth piece connector, and a vapor tube extending downwards from the lower end of the mouth piece assembly;
an e-liquid storage assembly, having an upper end detachably connected to the lower end of the mouth piece assembly through an e-liquid injection tube detachably inserted into the vapor tube, and an opposite, lower end;
a heating assembly having one or more ceramic e-liquid media for absorbing e-liquid to be vaporized, one or more heating wires to vaporize the e-liquid absorbed in the ceramic e-liquid media, each of the heating wires has a positive terminal and a negative terminal, wherein the heating assembly is disposed inside of the e-liquid storage assembly;
a vapor adjusting ring adapted for adjusting vapor flow; and
an electric connector assembly having a lower tubular body, electrically connected to a connecting ring assembly and an upper tubular body, wherein the upper tubular body has an upper end threaded into the lower end of the mouth piece assembly and an opposite, lower end threaded into an upper end of the connecting ring assembly.

2. The electronic cigarette of claim 1, comprising:
one or more vapor tubes on the mouth piece assembly;
one or more heating assemblies; and
one or more e-liquid storage assemblies,
wherein the electronic cigarette has the same number of vapor tubes, the heating assemblies, and the e-liquid storage assemblies, each of the one or more heating assemblies has an e-liquid injection tube detachably inserted into a corresponding vapor tube of the mouth piece assembly, and each of the one or more heating assemblies is disposed inside of a corresponding e-liquid storage assembly.

3. The electronic cigarette of claim 2, comprising two vapor tubes, two heating assemblies, and two e-liquid storage assemblies.

4. The electronic cigarette of claim 2, wherein the electric connector assembly comprises:
a body connector sleeved and sealed outside of the one or more e-liquid storage assemblies;
an electric connector plate;
an electric contact pin extended downward;
a negative connector terminal electrically connected to the body connector; and
a positive connector terminal electrically connected to the electric connector plate and the electric contact pin, and electrically insulated from the body connector.

5. The electronic cigarette of claim 4, further comprising an insulation layer disposed between the body connector and the electric connector plate.

6. The electronic cigarette of claim 4, wherein the electric contact pin is a metal contact pin and it is electrically connected to the electric connector plate through a retractable connection.

7. The electronic cigarette of claim 4, wherein the electric contact pin is electrically connected to the electric connector plate through a threaded connection.

8. The electronic cigarette of claim 4, wherein the body connector comprises:
a lower tubular body rotatably sleeved with a vapor adjusting ring;
a plurality of body air intake holes arranged along the perimeter of the lower tubular body; and
a protrusion ring extended radially to align with an outside edge of the vapor adjusting ring,
wherein the vapor adjusting ring has a vapor adjusting groove adapted for adjusting air intake by covering and uncovering the plurality of body air intake holes as the vapor adjusting ring is rotated.

9. The electronic cigarette of claim 8, wherein each of the one or more e-liquid storage assemblies comprises
a vaporizer air intake hole;
an electric connector tube;
an e-liquid injection tube; and
an e-liquid storage tube having an upper end connected to the e-liquid injection tube, and an opposite, lower end connected to the electric connector tube.

10. The electronic cigarette of claim 9, wherein the path of air flow includes: the plurality of body air intake holes on the lower tubular body, the vaporizer air intake holes, the e-liquid storage assemblies, the e-liquid injection tubes, the vapor tubes, and the mouth piece.

11. The electronic cigarette of claim 9, wherein each e-liquid injection tube of the plurality of e-liquid storage assemblies is electrically connected to the electric connector plate.

12. The electronic cigarette of claim 11, wherein each of the positive terminal of the one or more heating assemblies is electrically connected to a corresponding e-liquid storage tube, a corresponding electric connector tube, the electric connector plate, and the corresponding electric contact pin, and each of the negative terminal of the one or more heating assemblies is electrically connected to the body connector.

13. The electronic cigarette of claim 9, wherein the body connector is engaged with a threaded connecting ring, wherein the internal wall of the threaded connecting ring is threadedly engaged with the one or more e-liquid storage assemblies, and the external wall of the threaded connecting ring is threadedly engaged with the body connector.

14. The electronic cigarette of claim 9, wherein the threaded connecting ring has a threaded connecting ring support extending radially to be aligned with the outside edge of the vapor adjusting ring, and the connecting ring assembly is disposed on and supported by the threaded connecting ring support, and rotatably engaged with the threaded connecting ring support.

15. The electronic cigarette of claim 9, wherein the vapor adjusting ring includes an upper end, and an opposite, lower end rotatably and slidably engaged with the protrusion ring of the electric connector assembly.

16. The electronic cigarette of claim 15, wherein the protrusion ring of the electric connector assembly includes a position limit pin extending upward along the axis of the protrusion ring.

17. The electronic cigarette of claim 16, wherein the vapor adjusting ring has an arc shaped position limiting groove slidably engaged with the position limit pin to limit angle of the rotation of the vapor adjusting ring.

18. The electronic cigarette of claim 9, wherein the mouth piece is removable such that e-liquid can be refilled by removing the mouth piece and injecting e-liquid through the each of e-liquid injection tube of the plurality of the e-liquid storage assemblies.

19. A method of adjusting vapor flow of an electronic cigarette having a vapor adjusting ring and a plurality of body air intake holes, comprising an operation of rotating the vapor adjusting ring of the electronic cigarette.

20. The method of claim 19, wherein the rotating operation comprising:
rotating the vapor adjusting ring in one direction to uncover more of a plurality of the body air intake holes on the electronic cigarette to increase vapor flow; and
rotating the vapor adjusting ring in an opposite direction to cover more of the plurality of the body air intake holes on the electronic cigarette to decrease the vapor flow.
